(19) United States
(12) Patent Application Publication
(10) Pub. No.: US 2003/0095796 A1
(43) Pub. Date: May 22, 2003

(54) Apparatus for the uniform heating of substrates or of surfaces, and the use thereof

(76) Inventors: Jorg Eckert, Bruchkobel (DE); Robert Heinrich, Bessenbach (DE); Karl Hofler, Freigericht (DE)

Correspondence Address: FULBRIGHT & JAWORSKI, LLP, 666 FIFTH AVE, NEW YORK, NY, 10103-3198, US

(21) Appl. No.: 10/293,756

(22) Filed: Nov. 13, 2002

(30) Foreign Application Priority Data
Nov. 21, 2001 (DE) 101 56 915.7-34

(51) Int. Cl. F27D 11/00; F27B 5/14

(52) U.S. Cl. 392/418; 219/390; 392/424

(57) ABSTRACT

For the uniform heating of substrates or surfaces of metallic, mineral, organic or nonmetallic materials an infrared radiation source of at least one elongated tubular radiator is provided, while electrical terminals for supplying the radiator are situated in the cold area of a radiation housing; an infrared radiator with bases at least at both ends is configured as the infrared radiation source, which is situated with its radiating part in a tube chamber (1) with reflective surface which is open in the direction of emission, while the terminal ends of the radiator are each in end chambers (4, 5) closed off from the tube chamber (1) for protection against heating; the infrared radiation source has advantageously a plurality of infrared radiators which are arranged in a plane perpendicular to the direction of emission.

### BACKGROUND AND SUMMARY OF THE INVENTION

The invention relates to the uniform heating of substrates or surfaces of materials or material supports with an infrared radiation source with at least one elongated, tubular radiator and with a radiator housing having electrical connections for supplying the radiators, as well as with means for the production of infrared radiation acting on the substrates or surfaces, the proportion of the radiation acting upon the substrates or surfaces forming an important proportion of the total radiation power, and it relates also to the use of the apparatus.

The materials (including coatings) or material supports include metal, mineral, nonmetallic, organic and inorganic substances.

The radiation acting indirectly on the substrates or surfaces results from reflected radiation—for example by reflection from a layer of gold—and secondary radiation due to previous absorption of primary radiation, as disclosed, for example, in EP 0 554 538 B1; in the case of secondary radiation, infrared radiation is emitted with a wavelength range that is shifted from that of the primary radiation.

Such a proportion of the radiation acting upon the substrates or surface in the total radiation power is referred to as an “important proportion” if it at least ranges from 25 to 50% of the total radiation power.

In DE 199 38 808 A1 there is disclosed a method and an apparatus for the uniform heating of semitransparent and/or transparent glasses and/or glass ceramics in a temperature range of 20° C. to 3000° C. especially in the range of 700° C. to 1705° C., wherein the heating is achieved by a portion of the heat acting directly on the glasses and/or glass ceramic as well as a portion acting indirectly on the glasses and/or glass ceramic, while the portion of the radiation acting directly on the glass and/or the glass ceramics amounts to no more than 50% of the total radiation power. In an apparatus for the uniform heating of semitransparent and/or transparent glasses and/or glass ceramics, infrared radiation sources are provided for the emission of short-wavelength radiation, while means for the production of infrared radiation acting indirectly on the glasses and/or glass ceramics are so arranged and of such nature that the portion of the radiation acting indirectly on the glass and/or the glass ceramic by reflection and scatter amounting to more than 50% forms an important portion of the total radiation power. The apparatus comprises a plurality of infrared radiators which are arranged beneath a reflector. By the reflector it is brought about that the glass or glass ceramic to be heated is heated from the upper side. The infrared radiation put out by the infrared radiators passes through the glass materials or glass ceramic, which are largely transparent in this wavelength range and strikes a support plate made of highly reflective or highly scattering material. The heating apparatus and the material being treated are situated in an infrared radiation cavity equipped with infrared rays; this assumes that the quartz glass radiators themselves are sufficiently heat-resistant or cooled. The quartz glass tube can be used up to about 1100° C. Quartz glass tubes are used with preference which are considerably longer than the actual heating coil, so that the terminals are in the cool area and thus cannot be overheated.

Furthermore, DE 26 37 338 C3 discloses a cooled infrared radiator element of quartz glass or quartz material with an electric heating conductor arranged in an envelope tube as a voltage source, which has a cooling tube through which a coolant flows, and a reflector, wherein at least 10%, but no more than 90%, of the wall surface of the heating conductor envelope tube serves simultaneously as the wall surface of the cooling tube. The reflector is formed by a reflective coating which is applied to a surface of the cooling tube. A gold layer is used preferably as the reflective coating. One end of the cooling tube is sealed and its interior is divided with a space divider, while the connections for the inlet and outlet of the coolant are situated at one end of the radiator element. The electrical connections for the heater are arranged at the opposite end of the radiator element. In the known infrared radiator element, not only is an intensive cooling of the heating conductor provided, even in the case of high inherent radiation from the surroundings of the infrared radiator element, but also any evaporation of the reflective layer is securely avoided. The configuration of the infrared radiator element permits energy concentrations of up to 400 kW/m², so that it is possible to heat metallic materials and workpieces within a few minutes—i.e., shock-wise—to about 1000° C.

Furthermore, a high-power infrared radiation source is disclosed in DD 257 200 A1, which has an elongated incandescent radiator in an envelope tube, which is contained within a jacket tube. The envelope tube has several strip-like cylinder segments as reflecting surfaces, and also the jacketing tube is partially wrapped in a reflective cover. Between the envelope tube and the jacketing tube there is a cooling and filtering medium. The envelope tube is offset by 3 to 15% from the jacketing tube in the plane of the line of radiation from the radiation source.

In order to achieve maximum radiation power in the forward direction on a very small area, three cylinder segments are arranged as reflective surfaces on the envelope tube, and they are made of such a size that the space between two reflective surfaces is equal to the width of one reflective surface, and at the same time one reflective surface is made symmetrical with the reflective surface on the envelope tube running parallel to the latter. The temperature of the jacketing tube, and hence of all surfaces that can be touched from the outside remains low, so that the danger of burns appears to be excluded.

Furthermore, it is also possible, as in the case of the embodiment given in DE 26 37 338 C3, referred to in the beginning, to provide the electrical terminals on one end, which are cooled, and to place the connections for the inlet and outlet of water on the opposite end. Here, then, the end bearing two electrical terminals must, of course, be subjected to an especially great thermal stress, so that the intensity of the cooling must be improved, and convection cooling must be replaced by forced cooling.

The invention is addressed to the problem of creating a mounting for high-power infrared radiators which emit a very high energy density of about 1000 kW/m² with high efficiency; temperatures ranging from 800 to 3000° C. are to be achieved. Since a temperature of only about 250° C. is possible where the radiator is sealed in, due to the metal wire lead, an infrared radiator housing is to be developed in which the principal range comprises the central radiation areas for high radiation power, while areas divided therefrom are to be cool areas to contain the terminal ends.

The problem is solved by the invention in that the infrared radiation source is constructed as an infrared radiator with bases at both ends, which is situated with its radiating part in a tube chamber open in the direction of radiation emission and has a reflective surface, while the terminal ends are in end chambers (in the cold area of the radiation housing) which are divided off from the tube chamber.

It has proved to be advantageous that the overall efficiency of the apparatus is increased, while at the same time the heat-sensitive terminal ends of the radiators are protected against overheating. Another advantage is that the cooling of the terminal areas is possible both by forced convection and by natural convection.

In the case of natural convection virtually no impairment of the radiation power occurs; furthermore, any possible effect of outside air on the substrate is also prevented.

Advantageous embodiments of the invention are described herein as are methods of using the apparatus.

In a preferred embodiment the infrared radiation source has at least one infrared radiator which is disposed in a plane perpendicular to the direction of emission. The two end chambers are in air connection to a gas passage to ventilate the end chambers with cooling air.

The air connection to the end chambers, however, is also suitable for natural convection, so that even without forced convection a cold area is formed for the electrical terminals of the infrared radiators.

Furthermore, at least one infrared radiator is configured as a dual tube radiator having two tubes arranged and connected parallel to one another in one plane parallel to the direction of emission, which has a partial reflector on the inside of its tube, facing away from the emission of radiation, the tube being provided with at least one cooling water connection at each of its ends; in practice, a plurality—six, for example—of infrared radiators are arranged in one plane, which are each configured as water-cooled dual tube radiators.

The ends of the radiators are each held positively in an end wall of the channel, while the electrical terminals are separated by the side wall from the actual radiation field of the infrared radiators.

The tube chambers and the end chambers have walls of ceramic and/or ceramic material resistant to temperatures of more than 1000° C., aluminum oxide and/or silicon oxide being used with preference. The reflection of the radiation and the emission of the transformed radiation (secondary radiation) is preferably produced by ceramic and/or ceramic material, aluminum oxide and silicon oxide being preferred as ceramic, and aluminum oxide sponge as ceramic material.

The spectrum of the infrared radiation emitted is in the wavelength range above 0.8 μm, preferably at 0.9 to 1.5 μm.

The apparatus according to the invention is used preferably for the treatment of substrates or surfaces with infrared radiation.

The subject of the invention is further explained below in conjunction with FIGS. 1 and 2.

### BRIEF DESCRIPTION OF THE FIGURES

FIG. 1 shows a perspective view of the apparatus with its three chambers sealed off from one another, in which the radiation areas of the dual tube radiators are in the central tube chamber, while in the thermally insulated chambers laterally defining the tube chamber the terminal ends of the radiators mounted at both ends can be seen, which are in turn connected to an electrical supply line.

FIG. 2 shows a cross section taken through a radiation apparatus which is aimed at a treatment table bearing a radiation object, a ceramic substrate, for example.

### DETAILED DESCRIPTION

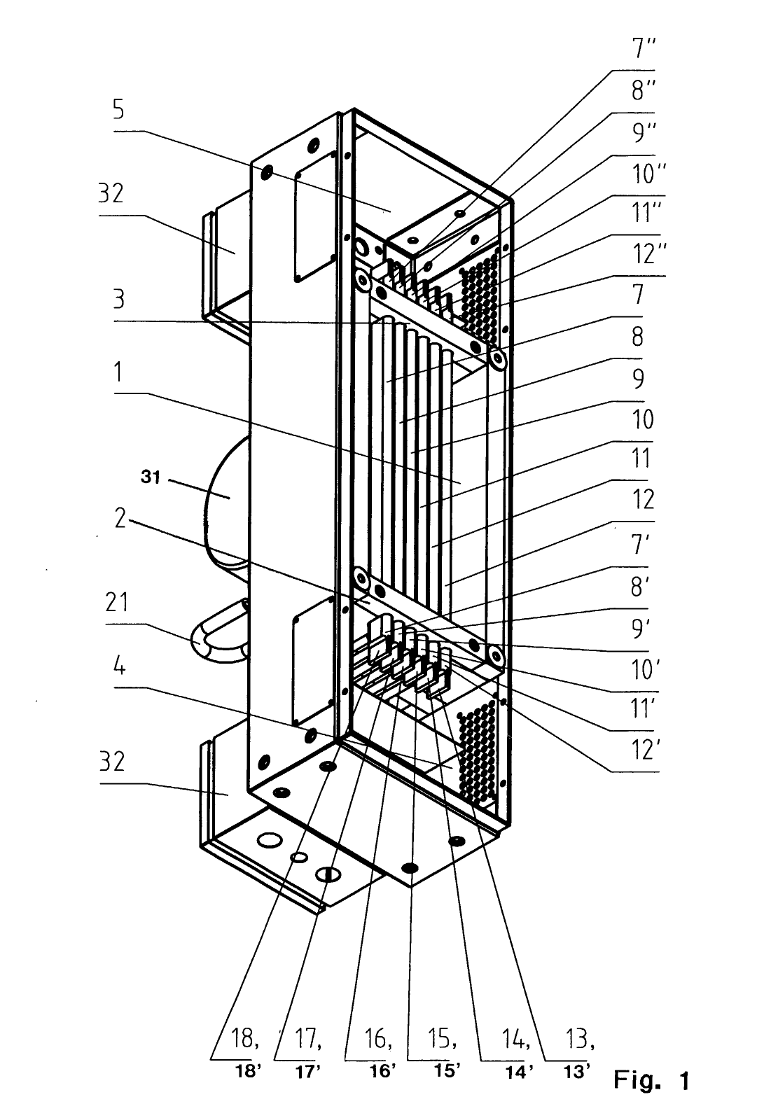

The apparatus represented in FIG. 1 has a housing with three chambers, of which a large central tube chamber 1 is provided for infrared radiation and is separated spatially and thermally by side walls 2 and 3 from the end chambers 4 and 5, respectively. In the plane of the front opening of chamber 1, the main radiation areas of a total of six elongated dual tube infrared radiators 7, 8, 9, 10, 11 and 12 are shown, while the terminal ends 7′, 8′, 9′, 10′, 11′ and 12′ and the axially opposite terminal ends 7″, 8″, 9″, 10″, 11″ and 12″ are positively borne by the respective dividing walls 2 and 3. Each of the terminal ends is in turn connected to a connecting conductor 13, 14, 15, 16, 17 and 18, and matching terminals are also provided in end chamber 5 and terminal boxes 32 in the terminal plane but are not visible here.

On account of the dual tube design of the infrared radiators, the terminal ends additionally have the possibility of a cooling water feed; the water connecting lines 13′, 14′, 15′, 16′, 17′ and 18′ are made of flexible tubing, so that cooling water is delivered and can be carried along the coaxially shaped annular interstices of the radiators 7, 8, 9, 10, 11 and 12.

In practice, the forced ventilation of the two end chambers 4 and 5 to cool the terminal ends is achieved by the fan 31, here represented schematically, but it is also possible to use natural convection within the end chamber 4 and 5 for the removal of heat. The water feed is performed, for example, through a connection end 21, here shown symbolically.

All of the radiators 7, 8, 9, 10, 11 and 12 have a reflector on their side remote from the emission of radiation from chamber 1; the radiator consists preferably of a thin layer of gold which is in no way harmed by heat from the cooling water flowing through them.

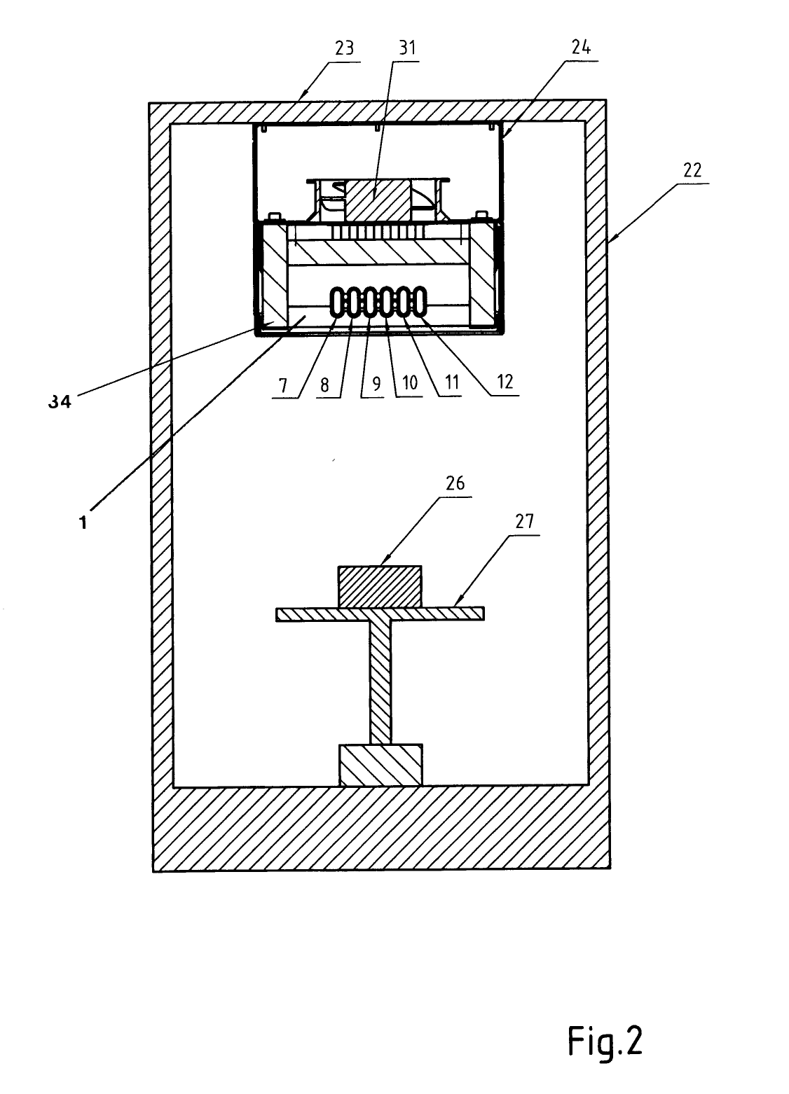

In the cross section in FIG. 2 there can be seen a complete radiation apparatus 22 whose upper part 23 holds the radiation apparatus 24 of the invention such that the radiation emission opening of chamber 1 faces downward.

In FIG. 2 it can be seen that all radiators 7, 8, 9, 10, 11 and 12 are in a single plane, and it is possible to optimize the irradiation of the substrate 26 by varying the distance from the substrate by adjusting the substrate holder or mounting 27, so that an optimum distance can be established. It is also possible, however, to arrange the radiators in a different form—in a radial shape, for example—so that the radiation emission surface is in the shape of a hollow cylinder or hollow cylindrical segment. The housing 34 containing the radiators consists preferably of thermally insulating ceramic, a ceramic material or refractory material, while the outer envelope, and thus the external housing, can consist of a metallic material or heat-resistant material with a thermal stability of up to about 200° C.

It is claimed:

1. Apparatus for the uniform heating of substrates or surfaces of materials or material supports, with an infrared radiation source with at least one elongated tubular radiator and with a radiator housing containing electrical connections for supplying the radiator, and with means for the production of infrared radiation acting indirectly on the substrates or surfaces, the content of radiation acting indirectly on the substrates or surfaces forming a substantial proportion of the total radiation power, characterized in that the infrared radiation source is configured as an infrared radiator (7, 8, 9, 10, 11, 12) with bases at least at both ends, which is situated with its radiating part in a tube chamber (1) with reflecting surface, while the terminal ends of the radiator are situated each in end chambers (4, 5) closed off from the tube chamber (1).

2. Apparatus according to claim 1, characterized in that the infrared radiation source has at least two infrared radiators which are arranged in a plane perpendicular to the radiation direction.

3. Apparatus according to claim 1 or 2, characterized in that a gas channel for passing cold air through the end chambers (4, 5) is provided in each case.

4. Apparatus according to any one of claims 1 to 3, characterized in that at least one infrared radiator is used as a dual tube radiator with two tubes arranged parallel to one another and joined to one another, the tube disposed on the side facing away from the direction of radiation being connected to a cooling water circuit for the flow [of water] through it.

5. Apparatus according to claim 4, characterized in that the infrared radiators (7, 8, 9, 10, 11, 12) consist each of two tubes of quartz glass arranged in a plane parallel to the direction of radiation, a first one being configured as an infrared radiator, while the second contains a coolant, the tube provided with coolant having a partial reflector for infrared radiation.

6. Apparatus according to claims 1 to 5, characterized in that the tube chamber (1) and end chambers (4, 5) having walls of ceramic and/or of ceramic thermal insulating material with a temperature stability ≧1000° C.

7. Apparatus according to claim 6, characterized in that aluminum oxide is used as ceramic.

8. Apparatus according to claim 6, characterized in that SiO₂ or Al₂O₃ ceramics are used as ceramic, thermal insulating material.

9. Apparatus according to any one of claims 1 to 8, characterized in that the ends of the infrared radiators (7, 8, 9, 10, 11, 12) are held each in a fitted manner by an end wall between tube chamber and end chambers.

10. Apparatus according to any one of claims 1 to 9, characterized in that the spectral range of the infrared radiation has a wavelength above 0.8 μm.

11. Use of the apparatus according to any one of claims 1 to 10 in a radiation apparatus (22) for the treatment of substrates (26) by infrared radiation.
